(19) United States
(12) Patent Application Publication
(10) Pub. No.: US 2007/0255705 A1
(43) Pub. Date: Nov. 1, 2007

(54) Method of evaluating document conformance

(75) Inventors: John M. Hoopes, Washington, IL (US); Douglas C. Meyer, Morton, IL (US); Pauline C. Agbodjan-Prince, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CATERPILLAR INC.

(21) Appl. No.: 11/412,931

(22) Filed: Apr. 28, 2006

(51) Int. Cl. G06F 17/30

(52) U.S. Cl. 707/6

(57) ABSTRACT

A method for evaluating documents is disclosed. The method includes compiling a database with at least one record indicative of at least one document that does not conform to at least one first criteria. The at least one record includes a first identifier. The method also includes compiling the database with first data indicative of the at least one document. The method also includes identifying at least one error associated with the at least one document. The at least one error is indicative of first data that does not conform to the at least one first criteria. The method further includes evaluating the at least one record, identifying at least one pattern associated with the at least one error, and amending the at least one record as a function of the identified at least one pattern.

### TECHNICAL FIELD

The present disclosure relates to a system for evaluating conformance and, more particularly, to a method and apparatus for evaluating document conformance.

### BACKGROUND

Systems for procuring products, such as, for example, goods or services, often include many documents that are transferred between entities, e.g., purchasers and suppliers, as the goods are manufactured, shipped, received, used, billed, and purchased. Typical documents include, for example, purchase orders, invoices, schedules, shipping notices, packing lists, and/or warehouse receipts, and may be hardcopy paper documents or electronic documents. Additionally, such documents usually include a plurality of data such as, for example, product numbers, supplier names or numbers, product descriptions, quantities, delivery dates, and/or other data known in the art. Often, documents are matched with other documents which correspond to common goods or services, e.g., a purchase order is matched with a shipping notice. Individual entities may each have unique formats and/or types of data associated with one or more particular documents. The effort required to compare and process documents having unique formats and/or types of data increases as a function of the differences. Additionally, entities attempting to utilize similar formats and/or types of data to reduce the required effort, must ensure compliance to realize benefits.

U.S. Patent Application Publication No. 2005/0187874 (“the '874 application”) filed by Sanal discloses an import compliance system and method. The system of the '874 application includes a compliance system configured to perform various checks with respect to data received via an electronic data interface (“EDI”). Specifically, the compliance system checks the data for formal conformance with expected formats and completeness, e.g., against predefined criteria, flags inconsistencies for remedial action, and ends its operation if inconsistencies are flagged. If the compliance system does not flag conformance inconsistencies, the system subsequently checks the data for compliance with requirements, e.g., customs requirements. The conformance and compliance checks of the system of the '874 application are performed to avoid delays and/or misrepresentations during an importation cycle.

Although the system of the '874 application may perform conformance and compliance checks, it may not track inconsistencies to identify patterns. Additionally, the system of the '874 application may not communicate with data providers to identify and resolve data submission issues affecting the inconsistencies.

The present disclosure is directed to overcoming one or more of the shortcomings set forth above.

### SUMMARY OF THE INVENTION

In one aspect, the present disclosure is directed to a method for evaluating documents. The method includes compiling a database with at least one record indicative of at least one document that does not conform to at least one first criteria. The at least one record includes a first identifier. The method also includes compiling the database with first data indicative of the at least one document. The method also includes identifying at least one error associated with the at least one document. The at least one error is indicative of first data that does not conform to the at least one first criteria. The method further includes evaluating the at least one record, identifying at least one pattern associated with the at least one error, and amending the at least one record as a function of the identified at least one pattern.

In another aspect, the present disclosure is directed to a work environment for evaluating conformance with respect to at least one document. The work environment includes a computer, a first database including first data indicative of at least one record and second data indicative of information associated with at least one document that does not substantially conform to first criteria, and a program. The program is configured to perform a first algorithm as a function of a second input received from the computer, the first algorithm configured to arrange the second data within the first database. The program is also configured to receive third data from the computer, compile the third data within the first database, and associate the third data with the at least one record. The program is further configured to compile fourth data within the first database indicative of information associated with at least one document and automatically delete a portion of the second data from the first database after a predetermined time period.

In yet another aspect, the present disclosure is directed to a method for reducing a quantity of non-conformance errors associated with a document. The method includes receiving the document from a supplier and comparing the document with a plurality of other documents. The method also includes identifying at least one error with the document with respect to first criteria and compiling a first database with data indicative of the document and associating the data indicative of the document with an identifier. The method also includes searching the database, identifying at least one pattern with respect to the at least one error, and communicating information to the supplier indicative of the at least one error or the at least one identified pattern.

### BRIEF DESCRIPTION OF THE DRAWINGS

FIG. 1 is a flow chart of an exemplary method for evaluating record conformance in accordance with the present disclosure; and

FIG. 2 is a schematic illustration of an exemplary work environment for performing the method of FIG. 1.

### DETAILED DESCRIPTION

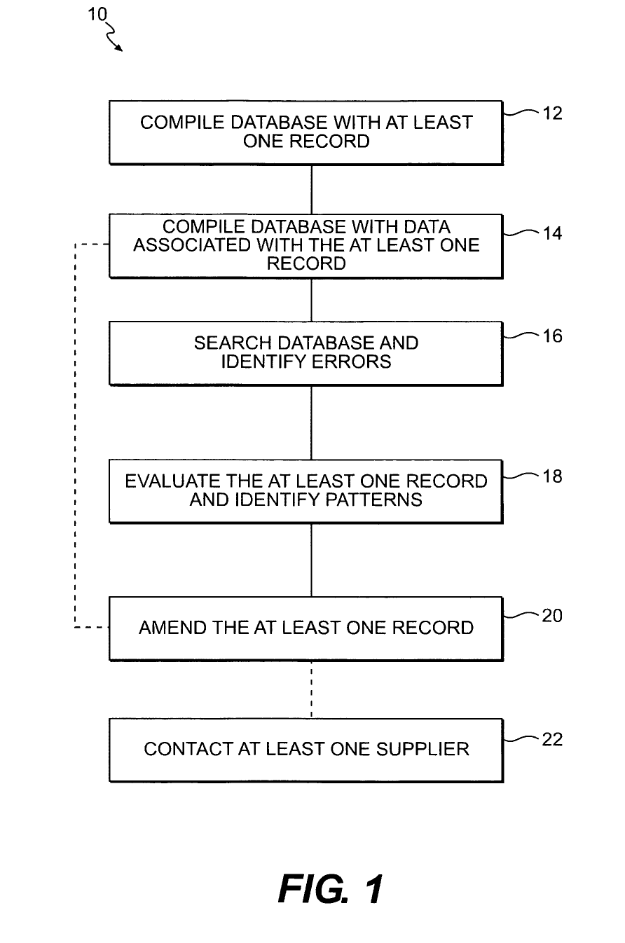

FIG. 1 illustrates an exemplary method 10 for evaluating document conformance. Method 10 may include compiling a database with at least one record, step 12, and compiling the database with data associated with the at least one record, step 14. Method 10 may also include searching the database and identifying errors, step 16, and evaluating the at least one record and identifying patterns, step 18. Method 10 may further include amending the at least one record, step 20, and contacting the supplier, step 22. It is contemplated that the steps associated with method 10 may be performed in any order and are described herein in a particular sequence for exemplary purposes only. It is also contemplated that method 10 may be performed continuously, periodically, singularly, as a batch method, and/or may be repeated as desired. It is further contemplated that method 10 may include repeating at least step 14 to compile the database with additional data associated with the at least one record.

Step 12 may include compiling a database with at least one record. Specifically, step 12 may include establishing a record within a database based on a given criteria, e.g., a name or code number associated with a supplier, a sequence number, or any other suitable identifier known in the art. The record may be indicative of at least one document that does not conform to specified, desired, or required criteria, e.g., standards or specifications, for documents or associated data. Step 12 may also include populating the database with data indicative of the at least one non-conforming document. For example, step 12 may establish a record by inputting data into a database indicative of a supplier that submitted a shipping notice that does not substantially conform to, e.g., match, a purchase order generated by a purchaser. It is contemplated that the data indicative of the at least one record may be recognized by an entity affiliated with the purchaser, e.g., accounts payable personnel, and communicated to and populated within the database via an electronic communication, e.g., a file transfer protocol. As such, step 12 may include compiling the database by receiving data indicative of non-conforming documents from the affiliated entity.

The non-conforming document may include a document that has one or more data fields that do not substantially correspond to a respective data fields of at least one other document, one or more data fields that do not conform to specified data arrangements, and/or may include a document that does not correspond to a specified format or timeliness. For example, step 12 may establish a record in the database for a supplier when a quantity of products associated with a shipping notice does not substantially match a quantity of products associated with any purchase orders and/or a part number associated with the shipping notice includes an insufficient quantity of digits as required by a part number specification. For another example, step 12 may establish a record in the database for a supplier when a document has been received in hardcopy format and not in electronic format as specified or when a document has not been received by a specified date. It is contemplated that step 12 may include compiling the database with a plurality of records and that any one of the plurality of records may include one or more non-conforming documents associated therewith. It is also contemplated that products may include any type or quantity of goods, e.g., parts or components, services, e.g., manipulations or specific performances, and/or any other object that may be desired to be procured. It is also contemplated that the types of non-conformance may include electronic data interface (“EDI”) errors. EDI errors include industry standard errors and classifications for unmatched or non-conforming documents. EDI errors are known in the art and, as such, are not further described herein. It is further contemplated that non-conformance may include documents received late or never received, e.g., as indicated by receiving goods prior to receiving a shipping notice.

Step 14 may include compiling data into the database indicative of data associated with one or more data fields of the non-conforming document, such as, for example, a purchase order, a part number, a ship date, a supplier code number, a quantity, a reference number, date, and/or a packing list number. Step 14 may also include compiling data into the database indicative of one or more non-conforming criteria, e.g., information indicative of the type of non-conformance or any EDI error. Specifically, step 14 may include inputting data into the database and associating the inputted data with the at least one record. For example, a particular supplier may have a plurality of non-conforming shipping notices associated therewith and step 14 may include inputting data indicative of one or more data fields of the plurality of non-conforming shipping notices into the database. For another example, a particular supplier may have a plurality of part numbers having insufficient digits associated therewith and step 14 may include inputting data indicative of the plurality of non-conforming part numbers into the database.

Step 14 may include inputting any quantity of data into the database and such data may be representative of any data field and/or non-conforming criteria. It is contemplated that a document may include any quantity of data fields and/or non-conforming criteria associated therewith. As such, the at least one record may be indicative of a particular supplier and the data associated with the record may be indicative of the information the particular supplier provides or submits within documents. It is also contemplated that the data may be associated or grouped within the record as a function of the document the data is associated with. For example, the data indicative of the information associated with a particular shipping notice may be grouped as such within the at least one record. It is further contemplated that step 14 may be repeated on a predetermined cycle, e.g., monthly or quarterly, and previously compiled data may be deleted after a predetermined time, e.g., two or four months. As such, step 14 may be configured to compile and maintain a particular number of months, e.g., two or four months, within the database for further manipulation.

Step 16 may include searching the database and identifying errors. Specifically, step 16 may include filtering the data associated with the at least one record according to one or more predetermined arrangements. For example, step 16 may include sorting the data according to any suitable criteria, e.g., ranking the data according to date, arranging the data according to types of data, searching the data to identify one or more data matching a search criteria, arranging the data according to types of non-conformance, any other data filtering technique known in the art, and/or combinations thereof. It is further contemplated that the step 16 may be performed by receiving one or more inputs, e.g., interface oriented object selections or text entries, from a user.

Step 16 may also include identifying errors within the searched data. Specifically, subsequent to step 16 arranging data according to desired criteria, step 16 may identify one or more errors associated with the data. The identified errors may or may not include the non-conforming criteria that established the non-conforming document and step 16 may include a user interfacing with the database to identify, e.g., recognize, such errors. For example, an error may be identified regarding the quantity of digits associated with data indicative of the part number, e.g., a user may identify that one or more digits of the part numbers are truncated. It is contemplated that a user may identify errors within step 16 manually and/or a subroutine may be executed which may identify errors automatically. It is also contemplated that step 16 may be configured to identify any error associated with the data and/or the record.

Step 18 may include evaluating the at least one record and identifying patterns. Specifically, step 18 may include identifying one or more associations, traits, qualities, and/or characteristics, of the data associated with the at least one record with respect to the identified errors. For example, step 18 may include inspecting data of the at least one record indicative of truncated part numbers and identify that such errors occurred on shipping notices received within a particular calendar week. For another example, step 18 may include inspecting data indicative of un-matching quantities and identify that such errors occurred when the supplier began supplying a new type of product to the buyer. It is contemplated that a user may identify patterns within step 18 manually and/or a subroutine may be executed which may identify patterns automatically, e.g., via one or more filter algorithms. It is also contemplated that step 18 may be configured to identify any type and/or quantity of pattern recognizable by a human operator or a programmed subroutine. It is further contemplated that the patterns identified within step 18 may be based on any suitable criteria and may be identified according to any suitable manner such as, for example, experience, training, matching to predetermined patterns, and/or any other manner known in the art.

Step 20 may include amending the at least one record. Specifically, step 20 may include inputting data indicative of the type of pattern, the suspected cause of the pattern, proposed corrective action to reduce or eliminate errors associated with the pattern, and/or indicative of any other data known in the art. Step 20 may also include associating the data with the at least record, such as, for example, by inputting data within a specified location with respect to the at least one record, e.g., a comment field. For example, step 20 may include inputting data indicative of the identified pattern of truncated part numbers occurring within a particular calendar week, as identified within step 18, and inputting data indicating that such an error has been previously corrected by providing training to supplier personnel, e.g., the error might be a result of untrained supplier personnel. It is contemplated that the data may be indicative of any alpha-numeric or symbolic text and may include any quantity thereof within system limits. Method 10 may, after step 20 executes, return to step 14 and/or may continue to step 22.

Step 22 may include contacting a supplier. Specifically, step 22 may include communicating with the supplier associated with the at least one record and informing the supplier of the type or quantity of errors, e.g., as determined within step 16, the identified patterns, e.g., as determined within step 18, and/or information configured to affect a reduction or elimination in the generation of the errors, e.g., recommendations, assistance, or training, and/or any other type of information known in the art. Step 22 may include sending an electronic mail message, a telephonic message or communication, and/or any other suitable communication to the supplier. For example, a user may inform a supplier that each of the shipping notices sent during a given calendar week included truncated part numbers and suggest to the supplier that the generation of such errors may be a result of new supplier personnel creating the shipping notices. For another example, a user may inform a supplier that shipping notices sent during a given calendar week were received after goods were received and suggest that the generation of such errors may a result of supplier personnel unaware the specified timeliness of shipping notices. It is contemplated that step 22 may also include inputting additional data into the database indicative the communication with the supplier and/or the content thereof.

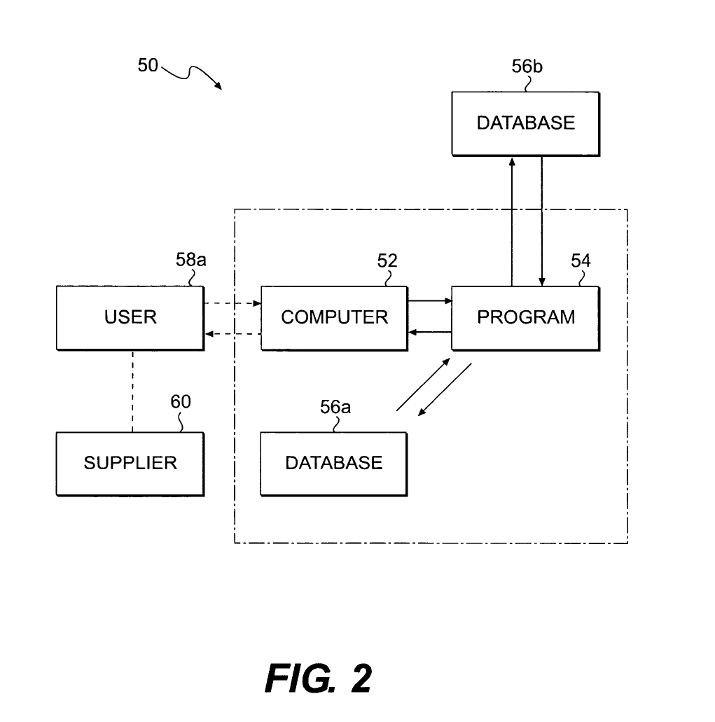

FIG. 2 illustrates an exemplary work environment 50 for performing method 10. Work environment 50 may include a computer 52, a program 54, and first and second databases 56a, 56b. Work environment 50 may be configured to accept inputs from a user 58 via computers 52 to evaluate document compliance. Work environment 50 may be further configured to communicate and/or display data or graphics to user 58 via computer 52. It is contemplated that work environment 50 may include additional components such as, for example, a communications interface (not shown), a memory (not shown), and/or other components known in the art.

Computer 52 may include a general purpose computer configured to operate executable computer code. Computer 52 may include one or more input devices, e.g., a keyboard (not shown) or a mouse (not shown), to introduce inputs from user 58 into work environment 50 and may include one or more output devices, e.g., a monitor, to deliver outputs from work environment 50 to user 58. Specifically, user 58 may deliver one or more inputs, e.g., data, into work environment 50 via computer 52 to supply data to and/or execute program 54. Computer 52 may also include one or more data manipulation devices, e.g., data storage or software programs (not shown), to transfer and/or alter user inputs. Computer 52 may also include one or more communication devices, e.g., a modem (not shown) or a network link (not shown), to communicate inputs and/or outputs with program 54. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 54 via, for example, a local area network (“LAN”), a hardwired connection, and/or the Internet. It is further contemplated that work environment 50 may include any number of computers and that each computer associated with work environment 50 may be accessible by any number of users for inputting data into work environment 50, communicating data with program 54, and/or receiving outputs from work environment 50.

Program 54 may include a computer executable code routine configured to perform one or more sub-routines and/or algorithms to evaluate document conformance within work environment 50. Specifically, program 54, in conjunction with user 58, may be configured to perform one or more steps of method 10. Program 54 may receive inputs, e.g., data, from computer 52 and perform one or more algorithms to manipulate the received data. Program 54 may also deliver one or more outputs, e.g., algorithmic results, and/or communicate, e.g., via an electronic communication, the outputs to user 58 via computer 52. Program 54 may also access first and second databases 56a, 56b to locate and manipulate data stored therein to arrange and/or display stored data to user 58 via computer 52, e.g., via an interactive object oriented computer screen display and/or a graphical user interface. It is contemplated that program 54 may be stored within the memory (not shown) of computer 52 and/or stored on a remote server (not shown) accessible by computer 52. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, e.g., C++, and/or may be configured to operate on any type of computer software, e.g., IBM's Lotus® software.

First and second databases 56a, 56b may be configured to store and arrange data and to interact with program 54. Specifically, first database 56a may be configured to store and arrange data indicative of the at least one record and data associated therewith compiled during steps 12 and 14 (referring to FIG. 1). Second database 56b may be configured to store and arrange data indicative of one or more documents associated with a system, e.g., a database compiled with data indicative of both conforming and non-conforming documents associated with a products procurement system. First and second databases 56a, 56b may store and arrange any quantity of data arranged in any suitable or desired format. Program 54 may be configured to access first and second databases 56a, 56b to identify particular data therein and display such data to user 58. It is contemplated that first and second databases 56a, 56b may include any suitable type of database such as, for example, a spreadsheet, a two dimensional table, or a three dimensional table, and may arrange and/or store data in any manner known in the art, such as, for example, within a hierarchy or taxonomy, in groupings according to associated documents, and/or searchable according to associated identity tags. It is also contemplated that second database 56b may be omitted and data indicative of the plurality of the one or more documents may be stored within first database 56a.

User 58 may include any entity configured to input data into and/or receive data from work environment 50. For example, user 58 may include a system manager configured to evaluate documents compiled within first database 56a and/or any other personnel associated with a purchaser. User 58 may, in conjunction with program 54, populate first database 56a with data indicative of the at least one record and data associated with one or more documents, search and identify errors, evaluate the at least one record and identify patterns, amend the at least one record, and may, contact a supplier 60. Specifically, user 58 may, in conjunction with program 54, perform one or more steps of method 10. It is contemplated that user 58 may include any number of different entities that each may perform any number of different steps and/or actions within method 10. It is also contemplated that supplier 60 may include any entity configured to provide goods and/or services to user 58 and/or an entity affiliated with user 58.

### INDUSTRIAL APPLICABILITY

The disclosed system may be applicable for evaluating conformance for any type of document. The description above and explanation below of method 10 is made with reference to a system for procuring products for exemplary purposes only, and it is noted that method 10 and work environment 50 may be applicable to any type of system wherein documents are evaluated for conformance. Additionally, method 10 is explained below with reference to user 58 performing one or more of the steps of method 10 via program 54 for exemplary purposes. It is noted that program 54 may automatically and/or semi-automatically perform one or more of the steps specifically explained as being performed by user 58.

A purchaser may desire to procure products from a supplier and may submit a purchase order to the supplier indicative of the type, quantity, and/or additional information regarding the products desired to be procured. The supplier may submit a shipping notice to the purchaser indicative of the type, quantity, and/or additional information regarding the products pending delivery to the purchaser. Upon receipt of the shipping notice, the purchaser may compare information, e.g., data, within the shipping notice with information, e.g., data, within a plurality of purchase orders to identify one of the plurality of purchase orders that substantially matches the shipping notice. If the purchaser does not identify such a purchase order, the purchaser may characterize, e.g., tag or otherwise identify, the unmatched shipping notice as a non-conforming document. For example, a shipping notice may be received including data that partially matches data of a purchase order, e.g., a shipping notice matches a purchase order except for a discrepancy between respective quantities, or a shipping notice may be received including data that does not match data of any purchase order, e.g., a supplier intends to deliver products that the purchaser does not desire to procure. For another example, a shipping notice may or may not be received after goods have been received and a warehouse receipt has been generated without a shipping notice.

Referring to FIGS. 1 and 2, first database 56a may be compiled with a record indicative of the unmatched shipping notice (step 12). For example, user 58 may input data into first database 56a indicative of a supplier 60 associated with the unmatched shipping notice. Additionally, user 58 may input data indicative of the shipping notice and/or supplier 60, such as, for example, data indicative of information within one or more data fields of the shipping notice, information regarding the reason the shipping notice does not match the purchase order, e.g., an error, a predetermined identifier, e.g., a reference code, and/or any other type of information associated with the unmatched shipping notice (step 14). User 58 may also input data into first database 56a indicative of one or more non-conforming shipping notices associated with supplier 60, that is, a supplier may submit a plurality of non-conforming shipping notices and user 58 may input data into first database 56a indicative of one or more of such shipping notices. As such, user 58 may establish data within first database 56a associated with supplier 60 and the one or more non-conforming shipping notices. It is contemplated that user 58 may input commands to program 54 to perform one or more algorithms configured to access second database 56b and transfer, e.g., copy, data therefrom into first database 56a.

User 58 may search first database 56a and identify one or more errors within the compiled data (step 16). For example, user 58 may apply one or more filter algorithms to the compiled data to arrange, e.g., sort, the compiled data according to desired criteria. Assuming that the compiled data for supplier 60 includes data indicative of a plurality of non-conforming shipping notices, user 58 may arrange the data according to particular types of errors, e.g., sort the compiled data within a hierarchy or taxonomy. For example, user 58 might operate an object oriented interface icon to sort data within a spreadsheet column, may perform a search to identify particular types of data, and/or perform any type of method known in the art to search the compiled data and identify errors therein. It is contemplated that the data within first database 56a may be displayed to user 58 via computer 52 and program 54 in any suitable manner, e.g., a graphical user interface and/or spreadsheet, in any suitable format, e.g., identifying a particular supplier and displaying one or more rows or columns of data, and/or in any suitable arrangement, e.g., according to shipping notice date. It is also contemplated that a display may be adjustable by the user or other operator and may be presented in any manner to facilitate user 58 interacting with the data.

User 58 may evaluate the one or more errors and identify patterns within the compiled data (step 18). For example, user 58 may, as a function of the identified errors (step 16), recognize that the part numbers submitted by supplier 60 include a substantial quantity of truncated part numbers each recevied within a particular calendar week. As such, user 58 may amend first database 56a by inputing data into the first database 56a indicative of the identified pattern (step 20). For example, user 58 may input text within a comment field indicating that certain part numbers are truncated and that such errors are associated with shipping notices received within a particular calendar week. It is contemplated that user 58 may identify any quantity of patterns and/or input any quantity of text referencing or describing the identified patterns.

User 58 may contact user 60 (step 22). For example, user 58 may send an electronic mail to supplier 60 informing supplier 60 of the identified patterns. Additionally, or alternatively, user 58 may telephonically contact supplier 60 and verbally discuss the identified pattern. User 58 may also provide suggestions or make recommendations to supplier 60 that, if implemented by supplier 60, may reduce and/or eliminate the occurrence of the errors identified within step 16. It is contemplated that user 58 may input data into first database 56a indicative of the communication user 58 conducted with supplier 60 and/or additional instructions, e.g., reminders, to user 58 and/or other users for subsequent action.

Steps 14, 16, 18, may be repeated to compile additional data from second database 56b to first database 56a. For example, shipping notices received by the purchaser since the last performance of step 14 may be compiled into first database 56a. It is contemplated that a portion of the data stored within first database 56a, e.g., data indicative of one or more shipping notices received before a predetermined time period, may be deleted from first database 56a. It is also contemplated that step 14 may be repeated on any schedule to periodically compile new data into first database 56a and/or delete previously compiled data from database 56a. As such, method 10 may be configured to maintain a quantity of data within first database 56a representative of non-conforming documents associated with a particular supplier for a given period of time, e.g., monthly, bi-monthly, tri-monthly, quarterly, and/or any other desired period. It is further contemplated that patterns may be recognized within step 18 and noted within step 20 regarding the trend of errors, e.g., increasing or decreasing quantities of errors, regarding the type of assistance communicated to supplier 60 within step 22 and the subsequent impact on the quantity of errors, and/or regarding any other type of information regarding the evaluation of non-conforming documents and the errors thereof.

Because method 10 may identify patterns associated with identified errors of non-conforming documents, such patterns and/or assistance may be communicated to suppliers to reduce and/or eliminate the occurrence of errors. Additionally, the reduction of errors may reduce the quantity of unmatched documents and thus may reduce costs associated with procuring products from suppliers. Furthermore, method 10 may improve business relations by improving the communications and transmittal of documents and/or products between a purchaser and a supplier.

It will be apparent to those skilled in the art that various modifications and variations can be made to the disclosed system for evaluating document conformance. Other embodiments will be apparent to those skilled in the art from consideration of the specification and practice of the disclosed method and apparatus. It is intended that the specification and examples be considered as exemplary only, with a true scope being indicated by the following claims and their equivalents

What is claimed is:

1. A method for evaluating documents comprising:
compiling a database with at least one record indicative of at least one document that does not conform to at least one first criteria, the at least one record including a first identifier;
compiling the database with first data indicative of the at least one document;
identifying at least one error associated with the at least one document, the at least one error being indicative of first data that does not conform to the at least one first criteria;
evaluating the at least one record and identifying at least one pattern associated with the at least one error; and
amending the at least one record as a function of the identified at least one pattern.

2. The method of claim 1, wherein:
identifying the at least one error includes arranging the first data in groupings of substantially similar first data; and
identifying the at least one pattern includes recognizing a trait associated with the at least one error.

3. The method of claim 1, wherein the identified at least one error is indicative of at least one of a first data field associated with the at least one document not conforming to at least one of a respective second data field associated with a second document, a first data field associated with the first document not conforming to a predetermined arrangement, or the at least one document not corresponding to a specified format.

4. The method of claim 1, further including contacting at least one supplier associated with the at least one record and communicating the identified at least one error to the at least one supplier.

5. The method of claim 4, further including communicating information configured to affect a reduction in the occurrence of the at least one identified error.

6. The method of claim 1, wherein amending the at least one record includes compiling the database with third data indicative of at least one of an identified error, a communication with a supplier, or a record status indicator.

7. The method of claim 1, wherein:
the first identifier is indicative of a supplier; and
the at least one document is a shipping notice that does not substantially match at least one purchase order.

8. A work environment for evaluating conformance with respect to at least one document comprising:
a computer;
a first database including first data indicative of at least one record and second data indicative of information associated with at least one document, the at least one document not substantially conforming to first criteria; and
a program configured to:
perform a first algorithm as a function of a second input received from the computer, the first algorithm configured to arrange the second data within the first database,
receive third data from the computer, compile the third data within the first database, and associate the third data with the at least one record, and
compile fourth data within the first database indicative of information associated with at least one document and automatically delete a portion of the second data from the first database after a predetermined time period.

9. The work environment of claim 8, further including a second database configured to store fifth data indicative of the at least one document, wherein the program is further configured to access the second database and populate the first database with the second data as a function of the fifth data.

10. The work environment of claim 8, wherein the first criteria is configured to determine when the at least one document does not conform to predetermined requirements for at least one of a type, arrangement, format, timeliness, or amount of information associated with the at least one document.

11. The work environment of claim 8, wherein:
the third data is indicative of a pattern of errors associated with the second data, the errors indicative of information associated with the at least one document not conforming to the first criteria.

12. The work environment of claim 8, wherein the first criteria is configured to identify information associated with the at least one document that does not conform to a predetermined arrangement for the information.

13. The work environment of claim 8, wherein the first criteria is configured to identify information associated with the at least one document that does not substantially match information associated with at least one other document.

14. The work environment of claim 13, wherein the at least one document is a shipping notice and the at least one other document is a purchase order.

15. The work environment of claim 8, wherein the predetermined period of time includes at least four months.

16. A method for reducing a quantity of non-conformance errors associated with a document comprising:
receiving the document from a supplier;
comparing the document with a plurality of other documents;
identifying at least one error with the document with respect to first criteria;
compiling a first database with data indicative of the document, and associating the data indicative of the document with an identifier;
searching the database and identifying at least one pattern with respect to the at least one error; and
communicating information to the supplier, the information indicative of the at least one error or the at least one identified pattern.

17. The method of claim 16, wherein the at least one error includes a plurality of errors, the method further including communicating additional information to the supplier, the additional information configured to affect a reduction in occurrence of the plurality of errors.

18. The method of claim 16 wherein the document includes a shipping notices and the plurality of other documents include a plurality of purchase orders.

19. The method of claim 16, further including compiling a second database with data indicative of the document received from the supplier and the identified error, the second database being different than the first database.

20. The method of claim 16, wherein:
the identifier is configured to identify the supplier;
the document is a plurality of documents;
the criteria is configured to identify information associated with each of the plurality of document that does not substantially match information associated with at least one of the plurality of other documents; and
compiling the first database with data includes inputting data into the first database indicative of the plurality of documents and associated each of the plurality of documents with the identifier.
